(19) United States
(12) Patent Application Publication
(10) Pub. No.: US 2016/0059946 A1
(43) Pub. Date: Mar. 3, 2016

(54) System and Method for Measuring Paddling Metrics

(71) Applicant: William K. Chen, Medford, MA (US)

(72) Inventor: William K. Chen, Medford, MA (US)

(21) Appl. No.: 14/834,999

(22) Filed: Aug. 25, 2015

Related U.S. Application Data
(60) Provisional application No. 62/041,663, filed on Aug. 26, 2014.

(51) Int. Cl. B63H 16/04; G09B 19/00; G01P 15/00

(52) U.S. Cl. CPC B63H 16/04; G01P 15/00; G09B 19/0038

(57) ABSTRACT

Disclosed are various embodiments for measuring metrics related to a person operating a paddling instrument. Upon receipt of motion sensor data received from a plurality of motion sensors attached to the paddling instrument, an application, executed in a computing device, can determine which side of a boat the person is paddling on, when the person starts the paddle stroke and ends the paddle stroke, and the angles of the paddle at the beginning and end of the stroke. As such, these metrics assist the person in determining their paddling efficiency and may aid the person in improving their paddling skills.

### CROSS REFERENCE TO RELATED APPLICATIONS

This application claims the benefit of, and priority to, co-pending U.S. Provisional Patent Application No. 62,041,663 entitled “PADDLE SENSOR TO MEASURE PADDLING METRICS” filed on Aug. 26, 2014, which is incorporated herein by reference in its entirety.

### BACKGROUND

Individuals participate in paddle sports for various reasons such as for exercise, for competitive reasons, and for recreational purposes. A paddler focuses on proper paddling technique with a paddle in order to improve speed and conserve energy.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is an example of a paddle with the paddle sensor attached, according to various embodiments of the present disclosure.

FIG. 1B is an example of a side view of the paddle with the paddle sensor attached illustrated in FIG. 1A, according to various embodiments of the present disclosure.

FIG. 2 illustrates an Isometric view of person on a paddleboard holding the paddle on the starboard side of the paddleboard, according to various embodiments of the present disclosure.

FIG. 3A is an example of paddle position at start of stroke on starboard side, according to various embodiments of the present disclosure.

FIG. 3B is an example of paddle position at end of stroke on starboard side, according to various embodiments of the present disclosure.

FIG. 4 illustrates an example of entry and exit points of paddle relative to paddler and paddleboard, according to various embodiments of the present disclosure.

FIG. 5A is an example view from the stern of the paddleboard showing the paddle at a roll angle of 0 degrees, according to various embodiments of the present disclosure.

FIG. 5B is an example view from the stern of the paddleboard showing the paddle at a roll angle of r degrees, according to various embodiments of the present disclosure.

FIG. 6A is an example view from the starboard side of the paddleboard showing the paddle at a pitch angle of 0 degrees, according to various embodiments of the present disclosure.

FIG. 6B is an example view from the starboard side of the paddleboard showing the paddle at a pitch angle of p degrees, according to various embodiments of the present disclosure.

FIG. 7 is an example block diagram of embedded system consisting of sensors, microprocessor and RF transmitter, according to various embodiments of the present disclosure.

FIG. 8 is a flowchart illustrating one example of functionality implemented as portions of the application to determine which side the paddler is paddling on, according to various embodiments of the present disclosure.

FIG. 9 is a flowchart illustrating one example of functionality implemented as portions of the application to determine when the paddler is starting and finishing the stroke, according to various embodiments of the present disclosure.

### DETAIL DESCRIPTION

Disclosed herein are various embodiments of a system and a method for measuring metrics related to paddling. The method described here applies to paddles such as those used for, but not limited to, Stand Up Paddling (SUP), Canoeing, Dragon Boating or Outrigger Canoe Paddling. The novel information determined by the system presented here comprises information about which side of the boat the person is paddling on, when the person starts the paddle stroke and ends the paddle stroke, and the angles of the paddle at the beginning and end of the stroke.

Metrics such as those listed above may help a paddler determine how efficient he or she is paddling and may aid in the paddler's training or practice to improve paddling skills. The present invention may include advantages such as performing direct measurements on the paddle rather than trying to infer stroke count through movement of the boat or movement of the human body, the claimed embodiment can use more sensor inputs than solely accelerometer based methods of measurement and can therefore combine measurements from different sensors to reject inaccuracies or noise from methods using less sensors, and the claimed embodiments are more versatile.

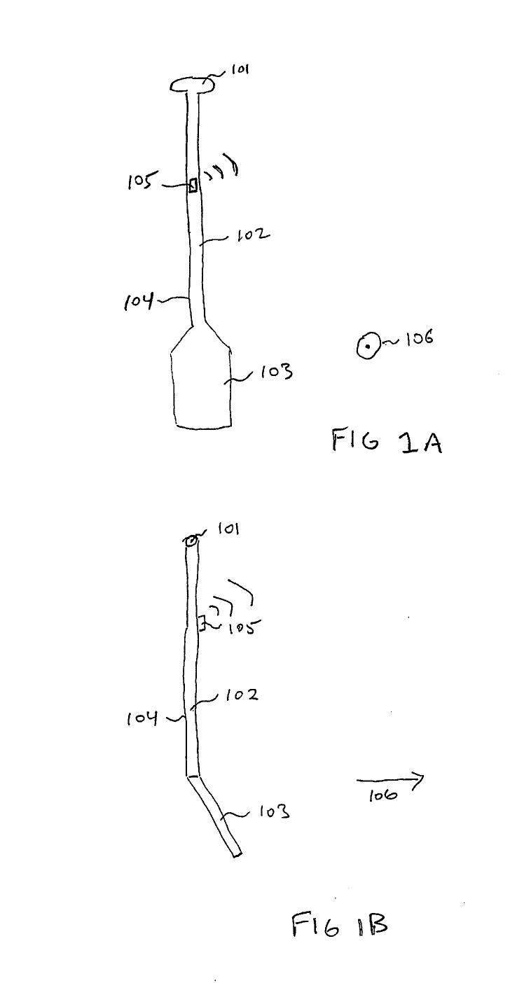

References will now be made in detail to the description of the embodiments as illustrated in the drawings. FIG. 1A shows a paddle 104 as viewed from the bow 201 of a boat, pictured as paddleboard 205. The paddle comprises a handle 101, a shaft 102 and a single blade 103. The paddle sensor 105 takes measurements, processes data and transmits information wirelessly. The paddle sensor 105 is rigidly attached to the paddle 104. The rigid attachment can be realized via a permanent method such as glue or epoxy, or via a temporary method such as a strap, temporary adhesive or velcro. Alternatively, it can be embedded in a rigid manner inside either the handle 101, shaft 102 or blade 103 of the paddle 104. FIG. 1B shows the same paddle as viewed from the side, specifically viewed from the starboard side of the boat.

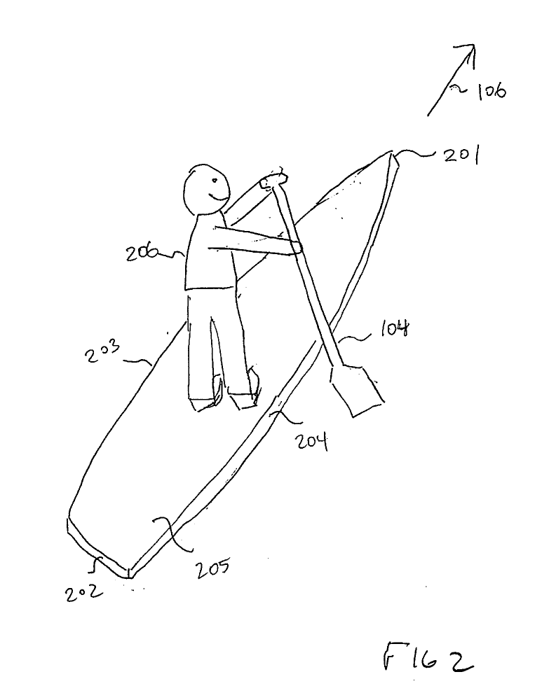

FIG. 2 shows the paddle 104, paddler 206 and boat 205. In this illustration, a Stand Up Paddleboard is depicted, though the boat could be but is not limited to: a canoe, outrigger canoe or dragon boat. The direction of travel is indicated by the arrow 106, and the following nautical terms relating to parts of the boat are labeled: the bow 201, the stern 202, the port side 203 and the starboard side 204.

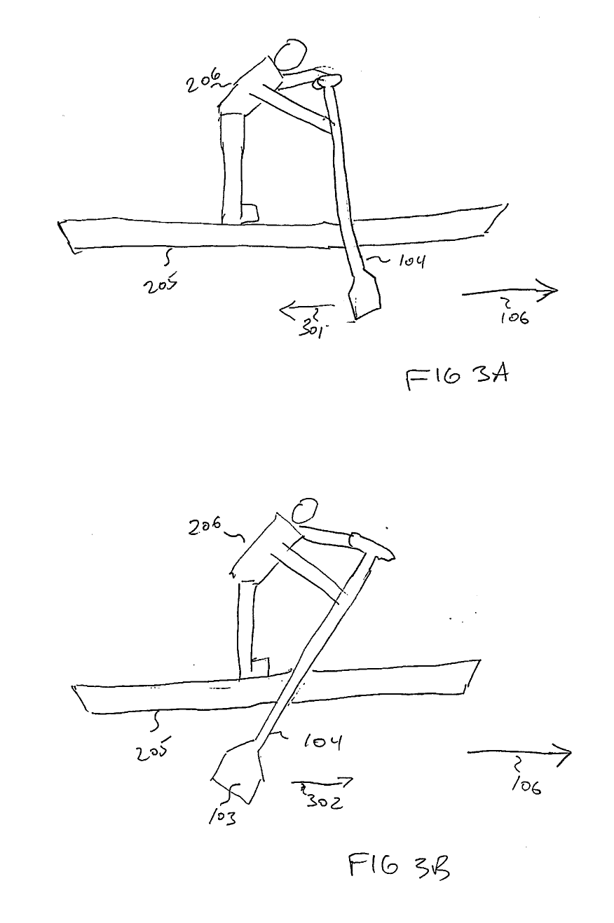

FIG. 3A depicts a paddler 206 starting a paddle stroke on the starboard side 204 of the boat. As the paddler 206 uses the paddle 104 to propel him or herself forward, the paddle will move in the direction 301 indicated relative to the boat 205. This motion is subsequently referred to as the stroke.

FIG. 3B depicts the position of the paddler 206 and paddle 104 at the end of the paddle stroke. Before the paddler 206 can take another stroke, he or she will raise the paddle 104 out of the water and move the blade 103 forward in the direction 302 to get back to the position depicted in FIG. 3A. This motion is subsequently referred to as the recovery.

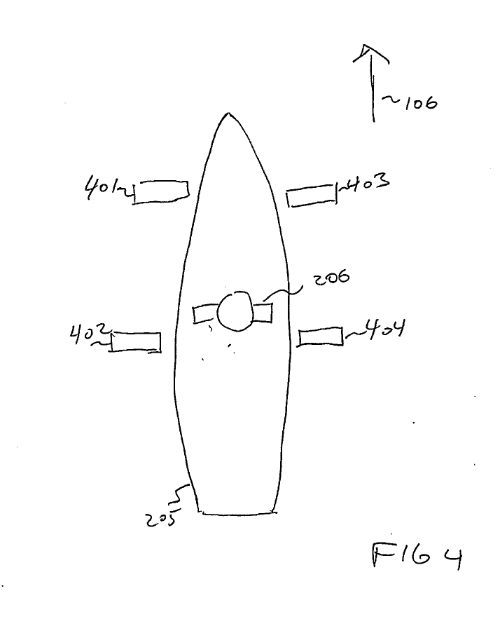

FIG. 4 depicts a top-down view of the boat 205 and the paddler 206. Also depicted are the likely start points of the starboard stroke 403, the starboard recovery 404, the port stroke 401 and the port recovery 402.

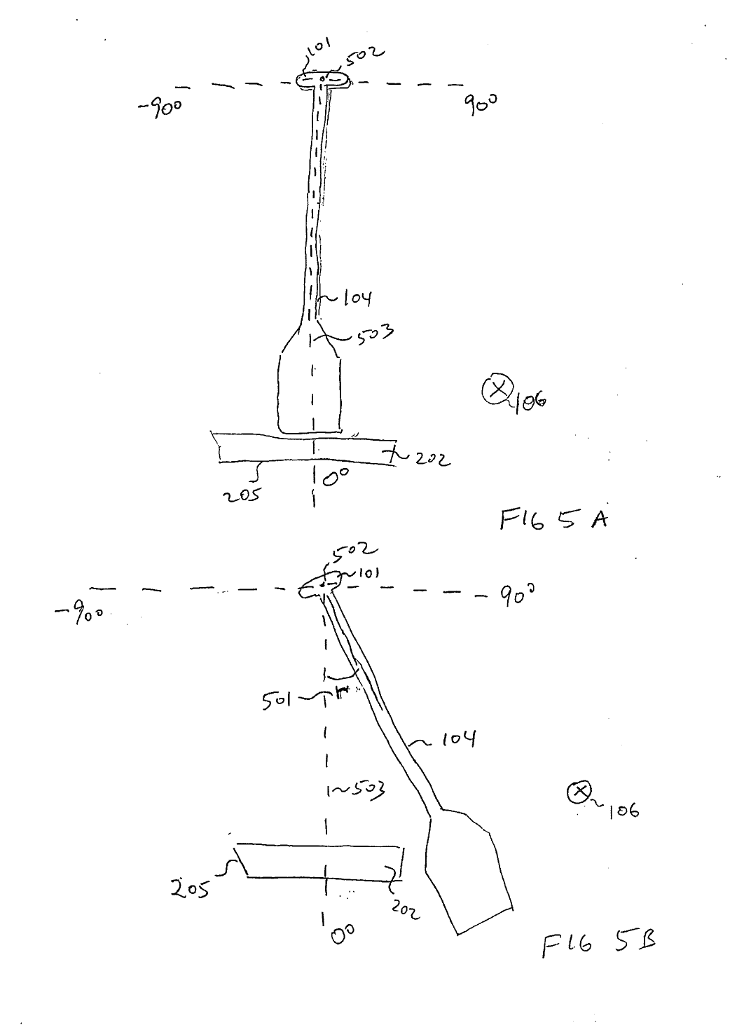

FIG. 5A depicts a view of the paddle 104 above the boat 205 as viewed from the stern 202. The dashed lines depict the paddle reference coordinate frame established for measuring the roll of the paddle. Note the origin 502 in the handle 101, as well as the vertical dashed line 503 in the direction of gravity, representing 0 degrees. Although the paddle reference coordinate frame is shown with 90, −90, and 0 references, it is understood that such the depicted paddle reference coordinate frame is one example of a reference coordinate system. It is intended that the axis representing 0 would be between the angle of the start of the stroke and the start of the recovery.

FIG. 5B shows the same perspective as 5A, but depicts the paddle at an angle of r 501 degrees in the paddle reference coordinate frame for roll.

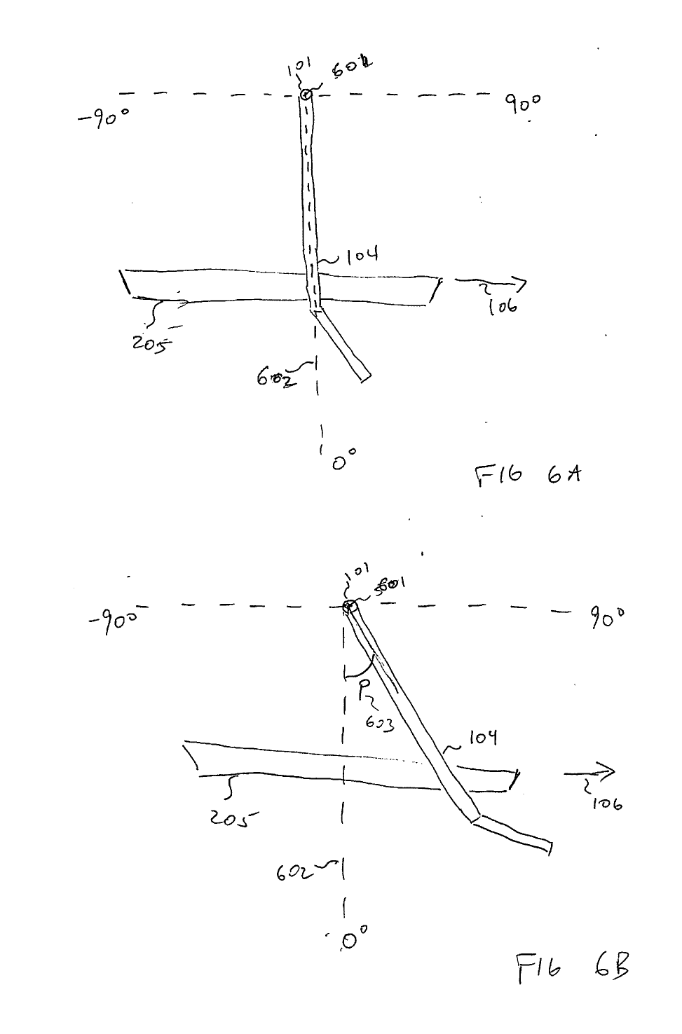

FIG. 6A depicts a view of the paddle 104 on the starboard side of the boat 205 as viewed from the starboard side. The dashed lines depict the paddle reference coordinate frame established for measuring the pitch of the paddle. Note the origin 601 in the handle 101, as well as the vertical dashed line 602 in the direction of gravity, representing 0 degrees. Although the paddle reference coordinate frame is shown with 90, −90, and 0 references, it is understood that such the depicted paddle reference coordinate frame is one example of a reference coordinate system.

FIG. 6B shows the same perspective as 6A, but depicts the paddle at an angle of p 603 degrees in the paddle reference coordinate frame for pitch. The origin 601 for the pitch coordinate reference frame may or may not be the same as the origin 502 for the roll coordinate reference frame.

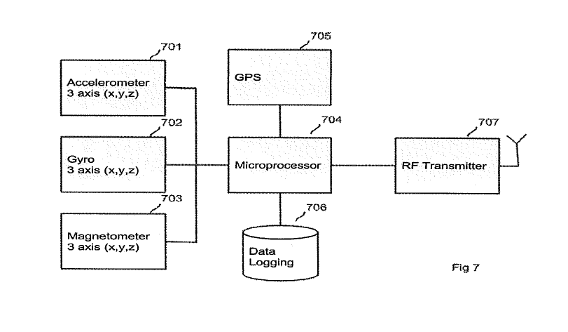

FIG. 7 is a block diagram of the paddle sensor. The three blocks on the left comprise a three axis accelerometer 701, a three axis gyroscope (gyro) 702, and a three axis magnetometer 703. These may be configured as discrete modules, or they may be combined in into one or more module. The sensors listed above feed their inputs to a microprocessor 704, which may or may not have both a GPS sensor 705 and data logging ability 706. Finally, the microprocessor 704 can transmit data wirelessly using an RF transmitter 707. Alternatively, data can be stored for later retrieval on the data logging component 706 or transferred off using a wired connection such as but not limited to a USB port.

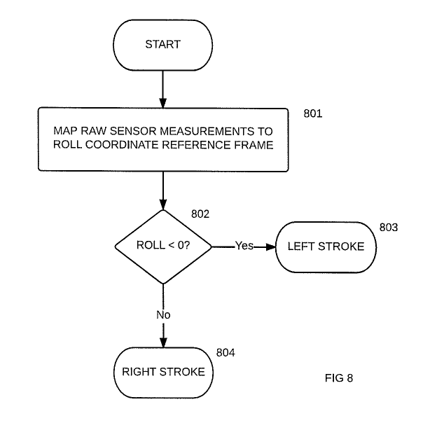

FIG. 8 is a flowchart depicting a simplified representation of the algorithm to determine which side the paddler is paddling on. When the roll measurement is negative, this corresponds to the port side. When the roll measurement is positive, this corresponds to the starboard side. The mapping from the raw measurements 801 to the roll coordinate frame can be done in a prepackaged inertial motion sensing module, or in software algorithms running in real time on a computational module, or in software algorithms running in a post processed environment. The determination of whether the roll angle is less than zero 802 can optionally be enhanced by setting hysteresis thresholds. For instance, in the transition from the roll being greater than zero to being less than zero, the decision block 802 may require the roll value to be less than zero by the hysteresis threshold in order to confirm that a left stroke 804 took place. Similarly, there may be a hysteresis threshold for the transition from the roll being less than zero (i.e. a left stroke) to being greater than zero (i.e. a right stroke)—in this case, the decision block 802 would require that the roll value be above zero by a certain threshold before making the determination that a right stroke 804 is taking place. The function of the hysteresis threshold would be to improve the performance of the algorithm by rejecting measurements that falsely indicate a change in the side on which the paddler is paddling, such as but not limited to sensor noise. There may be other algorithms which are used in conjunction with or in place of the hysteresis threshold that improve the detection of the side being paddle on.

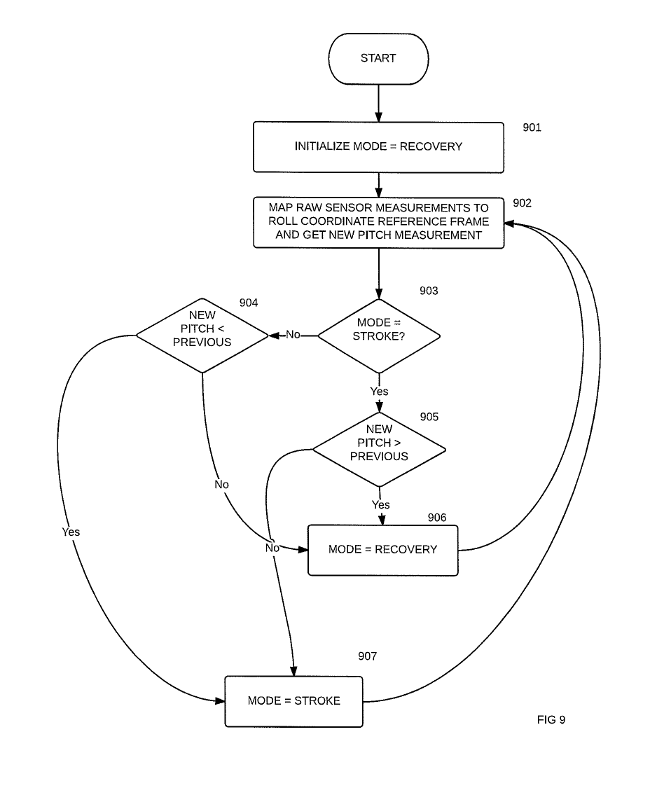

FIG. 9 is a flowchart depicting a simplified representation of the algorithm to determine when the paddler is performing a stroke and when the paddler is performing the recovery. The state of being in the stroke or recovery phases is referred to in FIG. 9 as the “mode” in 901, which starts out as the recovery. Optionally, this could start out as being the stroke. Similarly to FIG. 8, we start with a mapping of sensor values to the appropriate coordinate frame—this time, the pitch coordinate reference frame depicted in 6A and 6B. The algorithm operates in a loop which starts at 902. Similarly to the algorithm in FIG. 8, the determination of whether or not we are in a stroke or recovery mode relies on the determination of whether or not the pitch coordinate frame measurement is less than zero or not less than zero. This is combined with what the mode is currently to determine if we are switching from a stroke to recovery or vice versa. Just as in the algorithm behind FIG. 8, we can optionally implement a hysteresis threshold, so that the measurement has to go beyond zero by a certain amount in order to trigger the change in mode. The hysteresis threshold's function would be to reject false positive changes in mode or noise in measurements, which could happen if the paddler were resting while holding the paddle in place. In addition, other algorithms for noise rejection could be combined with or used in place of the hysteresis function. The algorithm depicted in FIG. 9 works independently from the algorithm depicted in FIG. 8. When they are used simultaneously, a determination can be made that the paddler is performing a left, a left recovery, a right stroke or a right recovery.

In order to accurately measure the attitude and orientation of the paddle, the paddle sensor needs to be rigidly fixed to the paddle throughout the duration of measurement and activity tracking.

In the course of paddling using a single bladed paddle, it should be noted that the orientation of the paddle usually stays the same in regards to the direction of travel. In other words, one face of the paddle blade 103 usually faces towards the paddler 206 and away from the bow, and the other face of the paddle blade 103 usually faces away from the paddler and towards the bow. Some single bladed paddles such as the SUP paddle depicted in 103 are designed from the start with this in mind—the blade is angled towards the direction of motion 106. Other single bladed paddles such as canoe paddles may be able to be used with either blade face forward—however, once a paddler starts to paddle, he or she may keep the same blade face forward in the interest of efficiency.

The 9 axis (accelerometer/gyro/magnetometer) measurements are collected by the microprocessor 704 in FIG. 7. The microprocessor could be but is not limited to a microcontroller, phone, tablet, smartwatch or other computing device. Once the microprocessor collects the measurements, they can be either stored locally, processed or transmitted to another computing or data storage device. The accelerometer, gyroscope and magnetometer may be contained in a smartphone, smartwatch or other device.

As depicted in the flowcharts in FIGS. 8 and 9, the 9 axis sensor data measurements are fused in the microprocessor, potentially converted to quaternions and then converted to the roll and pitch paddle coordinate reference frames depicted in FIGS. 5A, 5B, 6A and 6B. Once the measurements have been decomposed into roll and pitch angles, the algorithm can determine the respective paddle metrics. The pitch angles can be stored—the most positive pitch angle for each stroke corresponds to the angle of the paddle at the start of the stroke, and the most negative pitch angle corresponds to the angle of the paddle at the start of the recovery.

The algorithm depicted in code in FIG. 10 goes further than the simplified flowcharts in FIGS. 8 and 9 by introducing what is called a hysteresis threshold which helps with noise rejection. Once the algorithm determines that the paddler has switched direction from the stroke to the recovery, it waits for the paddle to travel a predetermined threshold distance in the direction of the recovery before making the final determination that the recovery has started. When the algorithm detects that the paddler has switched direction from the recovery to the stroke, it waits for the paddle to travel a predetermined threshold distance in the direction of the stroke before making the final determination that the stroke has started.

### Alternate Embodiments

The paddle sensor could be a smartphone, inertial measurement unit or any such device with accelerometers, gyroscopes and magnetometers that can measure the orientation of the paddle such as the angel r 501 in FIG. 5B or angle p 603 in FIG. 6B.

Quaternions can be used directly in place of Euler angles when determining the amount of paddle movement in the roll and pitch coordinate reference frames. The quaternions or euler angles may be computed in software or firmware, or they may be computed in hardware through the use of a chip that directly outputs the quaternions or euler angles.

Referring to FIG. 5B, the situation may occur where, although the angle r is positive when the paddle is on the starboard side of the boat, the angle r may become negative if, for example, the paddler leans out to the right so that, looking top-down, the handle is farther out from the starboard side, than is the blade. This is an inefficient method of paddling and usually unbalanced, so that it is normally only temporary. In order to not detect this as an erroneous change of side for the paddle from the starboard to the port side, we can employ a statistical method of detecting which side the paddle is on. For instance, we can require that a certain percentage of the measurements within a fixed time period indicate that r is either positive or negative before determining which side the paddle is on. This can be used in addition to the threshold detection mentioned previously.

Metrics such as minimum stroke or recovery time can be used for further noise rejection in determining valid start/stop times for the stroke and recovery. For example, a constraint could be made that the stroke phase must be at least 0.5 seconds, either based on physiological limits of the human body or accepted standards for technique. Measurements that indicate the start of the recovery phase before that 0.5 seconds were up would be ignored, and assumed to be caused by spurious noise or external motion factors unrelated to the paddling motion.

Because the paddle is a rigid object, the sensor can be fixed anywhere on the paddle or inside the paddle, as long as it stays in the same place. It would normally be placed where it doesn't interfere with the usage of the paddle by the paddler. It could be placed near the handle, near the blade or in the middle of the paddle.

There may be a GPS module included with the sensor. A GPS module may allow a measurement of course over ground (COG), which could improve the establishment and measurement of the roll and pitch coordinate frames.

The paddle sensor could be located somewhere not rigidly affixed to the paddle, as long as it can determine the paddle position according to the paddle coordinate reference frames for roll (FIGS. 5A/5B) and pitch (FIGS. 6A/6B) for the paddle. An example could be a video camera and associated processing software that can measure the paddle in the paddle coordinate reference frames, either on the boat being used by the paddler or off the boat.

The flowcharts of FIGS. 8 and 9 show functionality and operation of an implementation of portions of the application. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a microprocessor 704 in a computer system, a computing device, or other system. The machine code may be converted from the source code, etc. If embodied in hardware, each block may represent a circuit or a number of interconnected circuits to implement the specified logical function(s).

Although the flowcharts of FIGS. 8 and 9 show a specific order of execution, it is understood that the order of execution may differ from that which is depicted. For example, the r of execution of two or more blocks may be scrambled relative to the order shown. Also, two or more blocks shown in succession in FIGS. 8 and 9 may be executed concurrently or with partial concurrence. Further, in some embodiments, one or more of the blocks shown in FIGS. 8 and 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a paddle instrument;
a plurality of motion sensors coupled to the paddle instrument;
a computing device coupled to the plurality of motion sensors and the paddle instrument;
an application executable on the computing device, wherein the application, when executed, causes the computing device to at least:
receive motion data from at least one of the plurality of motion sensors;
determine a pitch angle based at least in part on the motion data; and
determine a position of the paddle instrument based on the pitch angle.

2. The system of claim 1, wherein the position comprises at least one of: a forward stroke indicating a start of a paddle stroke or a recovery stroke indicating an end of the paddle stroke.

3. The system of claim 1, wherein the plurality of motion sensors comprises an acceleration sensor and a rotation sensor, and the motion data comprises acceleration data and rotational data.

4. The system of claim 3, wherein determining the pitch angle based at least in part on the motion data further causes the computing device to perform a comparison between a pitch coordinate reference frame and the motion data.

5. The system of claim 3, wherein the plurality of motion sensors comprises a gravity sensor, and the motion data comprises gravitation data.

6. The system of claim 5, wherein the application further causes the computing device to determine a roll angle based at least in part on a comparison between a roll coordinate reference frame and the motion data.

7. The system of claim 6, further causes the computing device to at least determine which side of a boat the paddle instrument is being used based at least in part on the roll angle.

8. The system of claim 1, wherein the application further causes the computing device to least validate a change in the position of the paddle instrument based at least in part on the paddle instrument traveling a predefined distance toward an opposing paddle position.

9. A method comprising:
receiving, in a computing device, nine axis motion data from a plurality of motion sensors coupled to a paddle;
determining, in the computing device, a roll angle based at least in part on the nine axis motion data; and
determining, in the computing device, a paddle orientation based at least in part on the roll angle.

10. The method of claim 9, wherein the paddle orientation of the paddle indicates which side of a boat the paddle is being used.

11. The method of claim 9, wherein the plurality of motion sensors comprises a magnetometer sensor and an accelerometer sensor, and the nine axis motion data comprises acceleration data and gravitation data.

12. The method of claim 11, wherein determining, in the computing device, the roll angle further comprises determining a difference between a roll coordinate reference frame and the nine axis motion data.

13. The method of claim 9, wherein the plurality of motion sensors comprises a gyroscope sensor, and the nine axis motion data comprises rotation data.

14. The method of claim 9, further comprising:
determining, in the computing device, a pitch angle based at least in part a comparison between a pitch coordinate reference frame and the nine axis motion data; and
determining, in the computing device, a paddle location based at least in part on the pitch angle.

15. The method of claim 14, further comprising transmitting, via a radio frequency transmitter, the paddle location and the paddle orientation to a second computing device.

16. The method of claim 14, wherein the paddle location represents a forward stroke, the forward stroke indicating a start of a paddle stroke.

17. The method of claim 14, wherein the paddle location represents a recovery stroke, the recovery stroke indicating an end of a paddle stroke.

18. The method of claim 14, further comprising validating, in the computing device, a change in the paddle location based at least in part on the paddle traveling a predefined distance towards an opposing paddle location.

19. The method of claim 9, wherein determining, in the computing device, the paddle orientation further comprises determining that the paddle orientation is a left stroke based at least in part on the roll angle.

20. The method of claim 9, wherein determining, in the computing device, the paddle orientation further comprises determining that the paddle orientation is a right stroke based at least in part on the roll angle.
